(19) United States
(12) Patent Application Publication
(10) Pub. No.: US 2026/0322937 A1
(43) Pub. Date: Oct. 15, 2026

(54) IMAGE READING DEVICE AND IMAGE FORMING APPARATUS CAPABLE OF SUPPRESSING CHANGE IN FREQUENCY OF NOISE EMITTED FROM SUBSTRATE

(71) Applicant: KYOCERA Document Solutions Inc., Osaka-shi (JP)

(72) Inventor: Tatsuya Nakagawa, Osaka (JP)

(21) Appl. No.: 19/467,467

(22) Filed: Feb. 2, 2026

(30) Foreign Application Priority Data
Feb. 12, 2025 (JP) 2025-020489

(51) Int. Cl. H04N 1/024

(52) U.S. Cl. CPC H04N 1/02481; H04N 2201/0432; H04N 2201/0446

(57) ABSTRACT

An image reading device includes a substrate, a plate-like member, an attitude adjustment portion, and an attitude fixing portion. A photoelectric conversion element is mounted on the substrate. The plate-like member has conductivity, has the substrate fixed to an upper surface thereof, and is electrically connected to a ground of the substrate. The attitude adjustment portion includes a contact portion that comes into contact with a bottom surface of the plate-like member, and a movable portion that is provided to be movable along a vertical direction below the bottom surface, and is used for adjusting an attitude of the plate-like member. The attitude fixing portion fixes the attitude of the plate-like member after the adjustment by the attitude adjustment portion. In the image reading device, an energizing path provided from the plate-like member to a frame ground of the image reading device via the movable portion is shut off.

### INCORPORATION BY REFERENCE

This application is based upon and claims the benefit of priority from the corresponding Japanese Patent Application No. 2025-020489 filed on Feb.12, 2025, the entire contents of which are incorporated herein by reference.

### BACKGROUND

The present disclosure relates to an image reading device and an image forming apparatus.

An image reading device such as a scanner includes a light-emitting portion, a lens, and a substrate. The light-emitting portion emits light toward a document sheet. The lens collects the light that has been emitted by the light-emitting portion and reflected by the document sheet. A photoelectric conversion element which outputs an electric signal corresponding to the light in accordance with entering of the light that has passed through the lens is mounted on the substrate.

In the image reading device, an attitude of the substrate may be adjusted during manufacturing of the image reading device so that the light that has passed through the lens forms an image at an arrangement position of the photoelectric conversion element. For example, an image reading device including a plate-like member and an attitude adjustment portion is known. The plate-like member is arranged in an attitude along a horizontal plane, and the substrate is fixed to an upper surface thereof. The attitude adjustment portion includes a contact portion and a movable portion that support the plate-like member below the plate-like member. The movable portion is provided to be movable along a vertical direction. An operator performing a manufacturing operation of the image reading device can move the movable portion along the vertical direction to adjust the attitude of the substrate fixed to the plate-like member.

### SUMMARY

An image reading device according to an aspect of the present disclosure includes a light-emitting portion, a lens, a substrate, a plate-like member, an attitude adjustment portion, and an attitude fixing portion. The light-emitting portion emits light toward a document sheet. The lens collects the light that has been emitted by the light-emitting portion and reflected by the document sheet. On a substrate, a photoelectric conversion element is mounted, the photoelectric conversion element outputting, in accordance with entering of the light that has passed through the lens, an electric signal corresponding to the light. The plate-like member has conductivity, is arranged in an attitude along a horizontal plane, has the substrate fixed to an upper surface thereof, and is electrically connected to a ground of the substrate. The attitude adjustment portion includes a contact portion that comes into contact with a bottom surface of the plate-like member, and a movable portion that is provided to be movable along a vertical direction below a position on the bottom surface, that is different from a contact position at which the contact portion comes into contact with the bottom surface, the attitude adjustment portion being used for adjusting an attitude of the plate-like member. The attitude fixing portion which includes an opposing portion that opposes a surface of the plate-like member, and an adhesive that causes the surface and the opposing portion to adhere onto each other, and fixes the attitude of the plate-like member after the adjustment by the attitude adjustment portion. In the image reading device, an energizing path provided from the plate-like member to a frame ground of the image reading device via the movable portion is shut off.

An image forming apparatus according to another aspect of the present disclosure includes the image reading device and an image forming portion. The image forming portion forms an image read by the image reading device from the document sheet on a sheet.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing a configuration of an image forming apparatus according to an embodiment of the present disclosure;

FIG. 2 is a diagram showing a configuration in a periphery of a sensor substrate in the image forming apparatus according to the embodiment of the present disclosure;

FIG. 3 is a diagram showing a configuration of an attitude adjustment portion in the image forming apparatus according to the embodiment of the present disclosure;

FIG. 4 is a diagram showing a configuration in a periphery of a sensor substrate in an image forming apparatus according to another embodiment of the present disclosure; and

FIG. 5 is a diagram showing a configuration in a periphery of a sensor substrate in an image forming apparatus according to another embodiment of the present disclosure.

### DETAILED DESCRIPTION

Hereinafter, embodiments of the present disclosure will be described with reference to the attached drawings. It is noted that the following embodiments are each an example of embodying the present disclosure and do not limit the technical scope of the present disclosure.

### Configuration of image forming apparatus 100

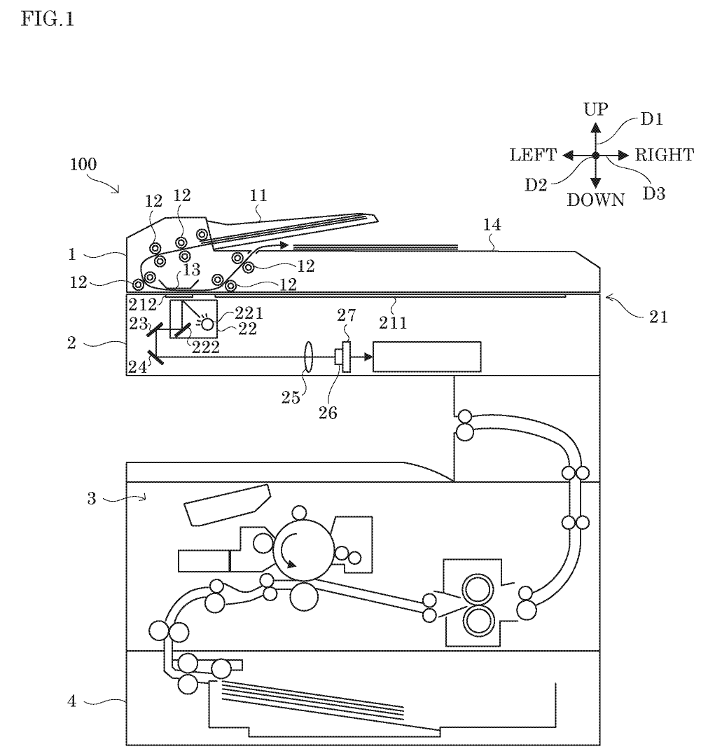

First, a configuration of an image forming apparatus 100 according to an embodiment of the present disclosure will be described with reference to FIG. 1. Here, FIG. 1 is a cross-sectional diagram showing the configuration of the image forming apparatus 100.

It is noted that for convenience of descriptions, a vertical direction in a state where the image forming apparatus 100 is installed in a usable state (a state shown in FIG. 1) is defined as an up-down direction D1. In addition, a front-rear direction D2 is defined with a surface of the image forming apparatus 100 on a near side of a sheet surface shown in FIG. 1 being a front surface (front side). In addition, a left-right direction D3 is defined using the front surface of the image forming apparatus 100 in the installed state as a reference.

The image forming apparatus 100 is a multifunction peripheral having a plurality of functions such as a facsimile function and a copying function in addition to a scanning function for reading an image from a document sheet and a printing function for forming an image based on image data. It is noted that the image forming apparatus according to the present disclosure is not limited to a multifunction peripheral, and may be a copying machine or the like.

As shown in FIG. 1, the image forming apparatus 100 includes an ADF (Auto Document Feeder) 1, an image reading portion 2, an image forming portion 3, and a sheet feed portion 4.

The image forming portion 3 forms an image read from a document sheet by the image reading portion 2 on a sheet. Specifically, the image forming portion 3 forms an image on a sheet using electrophotography. For example, the image forming portion 3 includes a photoconductor drum, a charging roller, a laser scanning unit, a developing device, a transfer roller, a cleaning device, a fixing device, and a sheet discharge tray. It is noted that the image forming portion 3 may form an image on a sheet using other image forming methods such as an inkjet method.

The sheet feed portion 4 supplies sheets to the image forming portion 3. The sheet feed portion 4 includes a sheet feed cassette and a plurality of conveying rollers.

The ADF 1 conveys a document sheet from which an image is to be read by the image reading portion 2. As shown in FIG. 1, the ADF 1 includes a document sheet tray 11, a plurality of conveying rollers 12, a document sheet guide 13, and a sheet discharge portion 14.

In the ADF 1, each of the conveying rollers 12 is driven by a driving force supplied from a motor (not shown). As a result, a document sheet placed on the document sheet tray 11 is conveyed along a document sheet conveying path formed inside the ADF 1. The document sheet conveyed along the document sheet conveying path is guided by the document sheet guide 13 to an upper surface of a second contact glass 212 (see FIG. 1) of a document sheet table 21, and is then discharged onto the sheet discharge portion 14.

The image reading portion 2 is capable of reading an image of a document sheet. Specifically, the image reading portion 2 is capable of reading an image of a document sheet using a CCD (Charge Coupled Device) method. As shown in FIG. 1, the image reading portion 2 includes the document sheet table 21, a reading unit 22, a mirror 23, a mirror 24, a lens 25, a CCD 26, and a sensor substrate 27. The image reading portion 2 is an example of an image reading device according to the present disclosure.

The document sheet table 21 is an upper surface portion of a box-shaped housing that houses each constituent element of the image reading portion 2. As shown in FIG. 1, the document sheet table 21 includes a first contact glass 211 and the second contact glass 212. A document sheet is placed on an upper surface of the first contact glass 211. The second contact glass 212 transmits light emitted from the reading unit 22 toward the document sheet conveyed by the ADF 1.

As shown in FIG. 1, the ADF 1 is provided above the document sheet table 21. The ADF 1 is provided such that an attitude thereof can be changed between a closed position at which the document sheet table 21 is covered and an opened position at which the document sheet table 21 is exposed. Thus, the ADF 1 functions as a document sheet cover for the document sheet placed on the first contact glass 211.

As shown in FIG. 1, the reading unit 22 is provided below the first contact glass 211 and the second contact glass 212. The reading unit 22 is configured to be movable along a sub-scanning direction (left-right direction D3) by a movement mechanism (not shown) including a drive portion such as a stepping motor. As shown in FIG. 1, the reading unit 22 includes a light-emitting portion 221 and a mirror 222.

The light-emitting portion 221 emits light toward a document sheet. The light-emitting portion 221 includes a plurality of LEDs arrayed along a main scanning direction (front-rear direction D2) perpendicular to the sub-scanning direction. The light-emitting portion 221 emits one line of light along the main scanning direction toward the first contact glass 211 or the second contact glass 212. The light emitted from the light-emitting portion 221 passes through the first contact glass 211 or the second contact glass 212 to be irradiated onto the document sheet placed on the first contact glass 211 or the document sheet conveyed by the ADF 1. The mirror 222 reflects the light that has been emitted from the light-emitting portion 221 and reflected by the document sheet to the mirror 23.

In the image reading portion 2, when an image is read from a document sheet placed on the first contact glass 211, the reading unit 22 is moved by the movement mechanism in the sub-scanning direction. Thus, the light that is emitted from the light-emitting portion 221 and irradiated onto the document sheet is scanned along the sub-scanning direction. Also in the image reading portion 2, when an image is read from a document sheet conveyed by the ADF 1, the reading unit 22 is moved by the movement mechanism to a position below the second contact glass 212. Thus, the light emitted from the light-emitting portion 221 passes through the second contact glass 212 to be irradiated onto the document sheet conveyed by the ADF 1.

The mirror 23 reflects the light that has been reflected by the mirror 222 of the reading unit 22 to the mirror 24. The mirror 24 reflects the light reflected by the mirror 23 to the lens 25. The lens 25 collects the light reflected by the mirror 24, that is, the light that has been emitted by the light-emitting portion 221 and reflected by the document sheet, and causes the light to enter the CCD 26.

In accordance with the entering of the light that has passed through the lens 25, the CCD 26 outputs an electric signal corresponding to the light. The CCD 26 is an image sensor including a plurality of photoelectric conversion elements arrayed along the main scanning direction. In the image reading portion 2, the light that has been emitted from the light-emitting portion 221 and reflected by the document sheet enters the CCD 26 via the mirror 222, the mirror 23, the mirror 24, and the lens 25. Thus, an analog electric signal corresponding to an image of the document sheet is output from the CCD 26. The analog electric signal output from the CCD 26 is converted into a digital electric signal (image data) by an AFE (Analog Front End) circuit (not shown) to be input to a control portion (not shown). The image data output from the image reading portion 2 is used for image formation by the image forming portion 3, and the like.

The CCD 26 is mounted on the sensor substrate 27. The sensor substrate 27 includes a drive circuit that drives the CCD 26. The sensor substrate 27 is an example of a substrate according to the present disclosure.

In the image forming apparatus 100, an attitude of the sensor substrate 27 is adjusted during manufacturing of the image forming apparatus 100 so that light that has passed through the lens 25 forms an image at the arrangement position of the CCD 26.

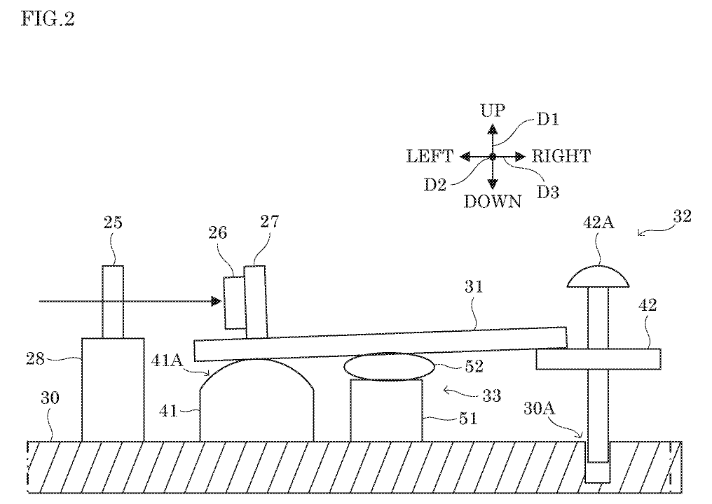

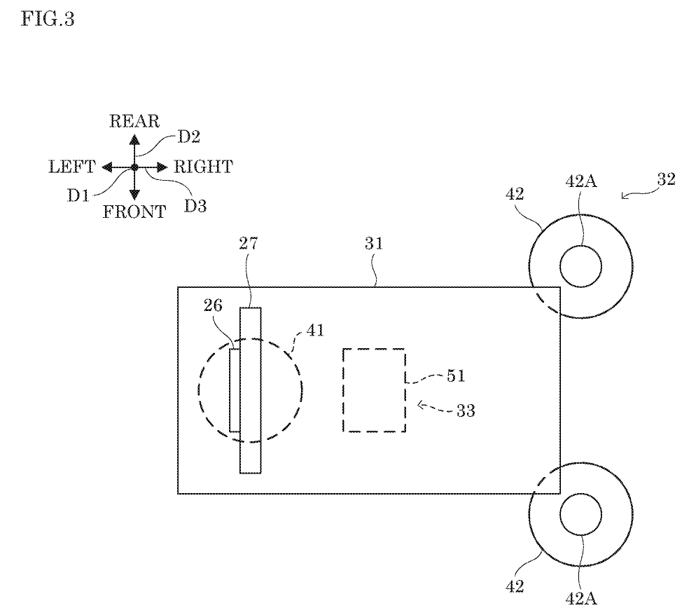

Specifically, the image reading portion 2 includes a support plate 31, an attitude adjustment portion 32, and an attitude fixing portion 33 shown in FIGS. 2 and 3.

### Configurations of support plate 31, attitude adjustment portion 32, and attitude fixing portion 33

Hereinafter, configurations of the support plate 31, the attitude adjustment portion 32, and the attitude fixing portion 33 will be described with reference to FIGS. 2 and 3. Here, FIG. 2 is a side view showing the configurations of the support plate 31, the attitude adjustment portion 32, and the attitude fixing portion 33. Further, FIG. 3 is a plan view showing the configurations of the support plate 31, the attitude adjustment portion 32, and the attitude fixing portion 33.

It is noted that in FIG. 2, a cross section of a bottom surface portion 30 that forms a bottom surface inside the housing of the image reading portion 2 is hatched. The bottom surface portion 30 is a part of a metal frame included in the housing. As shown in FIG. 2, the lens 25 is supported at a position above the bottom surface portion 30 by a support base 28 provided on the bottom surface portion 30.

As shown in FIGS. 2 and 3, the support plate 31 is a flat plate-like member having rectangular upper surface and bottom surface. The support plate 31 is arranged above the bottom surface portion 30 in an attitude along a horizontal plane. The sensor substrate 27 is fixed to the upper surface of the support plate 31. As shown in FIGS. 2 and 3, the sensor substrate 27 is arranged on a left end portion side of the upper surface of the support plate 31. The support plate 31 is a metal plate. In other words, the support plate 31 has conductivity. The support plate 31 is electrically connected to a ground of the sensor substrate 27. The support plate 31 is an example of a plate-like member according to the present disclosure. It is noted that the support plate 31 is not limited to a metal plate and only needs to be a member formed of a conductive material.

The attitude adjustment portion 32 is used for adjusting an attitude of the support plate 31. As shown in FIGS. 2 and 3, the attitude adjustment portion 32 includes a contact portion 41 and two movable portions 42.

As shown in FIGS. 2 and 3, the contact portion 41 is arranged at a position opposing the left end portion side of the support plate 31 on the bottom surface portion 30. The contact portion 41 is formed in a cylindrical shape erected on the bottom surface portion 30. As shown in FIG. 2, an upper surface portion 41A of the contact portion 41 is formed in a hemispherical shape. The upper surface portion 41A of the contact portion 41 comes into contact with the bottom surface of the support plate 31.

As shown in FIGS. 2 and 3, the two movable portions 42 are arranged between the bottom surface portion 30 and the support plate 31. The movable portions 42 are provided so as to oppose right-side corner portions of the support plate 31. In other words, each of the movable portions 42 is provided below a position on the bottom surface of the support plate 31, that is different from a contact position at which the contact portion 41 comes into contact with the bottom surface. As shown in FIGS. 2 and 3, each of the movable portions 42 is formed in a disk shape.

Each of the movable portions 42 is provided to be movable along the vertical direction (up-down direction D1). Specifically, each of the movable portions 42 is fixed to a screw 42A (see FIG. 2) that fits in a screwable manner into a screw hole 30A formed at the bottom surface portion 30 along the vertical direction (see FIG. 2). More specifically, each of the movable portions 42 includes a hole portion that penetrates a center portion of the circular upper surface and bottom surface. The screw 42A is inserted into the hole portion of each of the movable portions 42 to be fixed thereto. Thus, as the screw 42A rotates, each of the movable portions 42 advances and retreats integrally with the screw 42A along the vertical direction.

During manufacturing of the image forming apparatus 100, the support plate 31 is supported by the contact portion 41 and the two movable portions 42. An operator performing a manufacturing operation of the image forming apparatus 100 can rotate one or both of the two screws 42A respectively corresponding to the two movable portions 42, to adjust the attitude of the support plate 31 and the sensor substrate 27 fixed to the support plate 31.

The attitude fixing portion 33 fixes the attitude of the support plate 31 after the adjustment by the attitude adjustment portion 32. As shown in FIG. 2, the attitude fixing portion 33 includes an opposing portion 51 and an adhesive 52.

The opposing portion 51 opposes the bottom surface of the support plate 31. As shown in FIGS. 2 and 3, the opposing portion 51 is arranged at a position on the bottom surface portion 30, that opposes a center portion of the support plate 31. The opposing portion 51 is formed in a columnar shape erected on the bottom surface portion 30.

The adhesive 52 causes the bottom surface of the support plate 31 and an upper surface of the opposing portion 51 to adhere onto each other. The adhesive 52 is a UV adhesive that hardens when irradiated with ultraviolet rays.

During manufacturing of the image forming apparatus 100, the adhesive 52 is applied onto the upper surface of the opposing portion 51 before the support plate 31 is arranged above the opposing portion 51. The operator performing the manufacturing operation of the image forming apparatus 100 can adjust the attitude of the support plate 31 using the attitude adjustment portion 32 and then irradiate ultraviolet rays onto the adhesive 52, to fix the attitude of the support plate 31.

By fixing the attitude of the support plate 31, a situation where the screw 42A is rotated due to vibrations during conveyance of the image forming apparatus 100 and/or the like so that the movable portion 42 moves along the vertical direction and the attitude of the sensor substrate 27 changes accordingly is suppressed.

It is noted that the number of movable portions 42 to be included in the attitude adjustment portion 32 may be one, or three or more. Furthermore, the arrangement positions of the contact portion 41 and the two movable portions 42 below the support plate 31 are not limited to the positions shown in FIG. 3 and may be determined arbitrarily. Moreover, the arrangement position of the attitude fixing portion 33 below the support plate 31 is not limited to the position shown in FIG. 3 and may be determined arbitrarily.

Further, the adhesive 52 is not limited to a UV adhesive and may alternatively be an adhesive that hardens by irradiation of light different from ultraviolet rays, application of thermal energy, or the like. Furthermore, the opposing portion 51 may oppose a surface other than the bottom surface of the support plate 31. In this case, the adhesive 52 only needs to cause the support plate 31 and the opposing portion 51 to adhere onto each other.

Incidentally, high-frequency noise is emitted from the sensor substrate 27 along with the drive of the CCD 26. However, by providing an energizing path from the ground of the sensor substrate 27 to the bottom surface portion 30, which is a frame ground of the image reading portion 2, via the support plate 31 and the attitude adjustment portion 32, it is possible to suppress the emission of the noise.

Here, when the movable portion 42 moves downwardly due to vibrations during conveyance of the image forming apparatus 100 or the like after the attitude of the sensor substrate 27 is fixed using the adhesive 52, the energizing path provided from the ground of the sensor substrate 27 to the bottom surface portion 30 via the movable portion 42 is shut off, and the frequency of the noise emitted from the sensor substrate 27 changes accordingly. When the frequency of the noise changes after the shipment of the image forming apparatus 100, effectiveness of noise countermeasures implemented on the image forming apparatus 100 before the shipment of the image forming apparatus 100 is reduced.

In contrast, in the image forming apparatus 100 according to the embodiment of the present disclosure, it is possible to suppress a change in the frequency of the noise emitted from the sensor substrate 27 as will be described below.

Specifically, in the image forming apparatus 100, the energizing path provided from the support plate 31 to the bottom surface portion 30, which is the frame ground of the image reading portion 2, via the movable portion 42 is shut off.

More specifically, in the image forming apparatus 100, each of the movable portions 42 is formed of a material having an insulating property, such as a resin.

Also in the image forming apparatus 100, the contact portion 41 is formed of a material having conductivity, such as metal, and is electrically connected to the bottom surface portion 30.

Thus, it is possible to suppress the emission of the noise from the sensor substrate 27 and suppress a change in the frequency of the noise emitted from the sensor substrate 27.

### OTHER EMBODIMENTS

It is noted that means for shutting off the energizing path provided from the support plate 31 to the bottom surface portion 30 via the movable portion 42 is not limited to that described above.

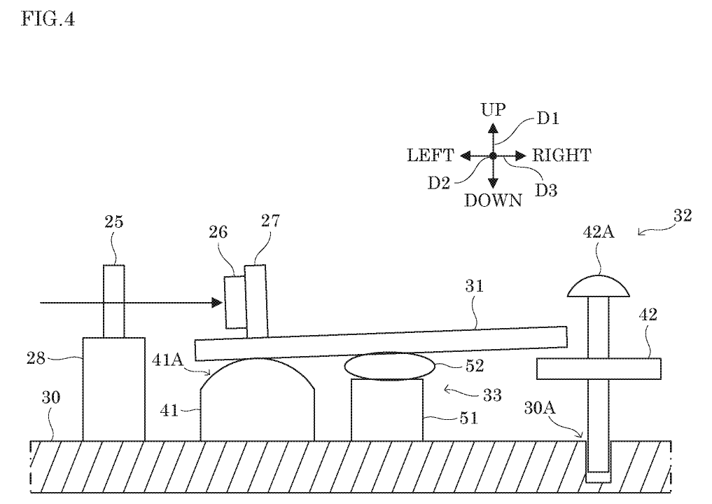

For example, each of the movable portions 42 may be arranged at a position apart from the bottom surface of the support plate 31 after the attitude of the support plate 31 is fixed by the attitude fixing portion 33 (see FIG. 4).

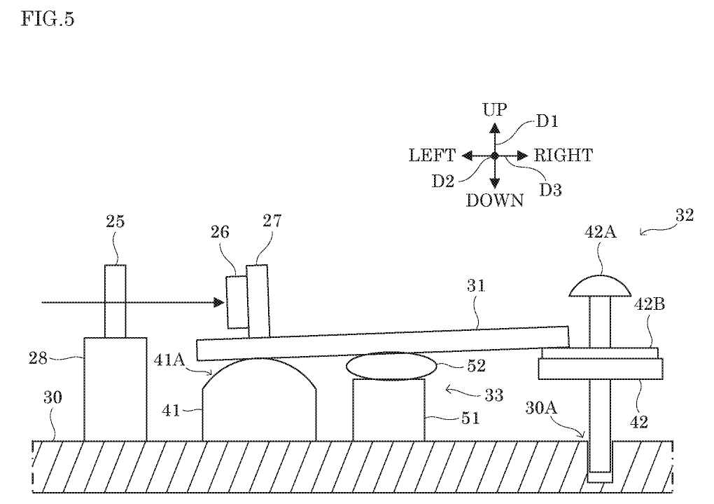

Further, the image reading portion 2 may include an insulating member 42B (see FIG. 5) interposed between each of the movable portions 42 and the support plate 31. For example, the insulating member 42B is a rubber sheet or the like that covers the upper surface of the movable portion 42.

Furthermore, instead of using the movable portions 42, each of the screws 42A may be formed of a material having an insulating property, such as resin.

Furthermore, the energizing path from the support plate 31 to the bottom surface portion 30, that corresponds to some of the plurality of movable portions 42, does not need to be shut off.

### Notes of disclosure

Hereinafter, a general outline of the disclosure extracted from the embodiment described above will be noted. It is noted that the respective configurations and processing functions described in the notes below can be sorted and arbitrarily combined as appropriate.

### Note 1

An image reading device, including: a light-emitting portion which emits light toward a document sheet; a lens which collects the light that has been emitted by the light-emitting portion and reflected by the document sheet; a substrate on which a photoelectric conversion element is mounted, the photoelectric conversion element outputting, in accordance with entering of the light that has passed through the lens, an electric signal corresponding to the light; a plate-like member which has conductivity, is arranged in an attitude along a horizontal plane, has the substrate fixed to an upper surface thereof, and is electrically connected to a ground of the substrate; an attitude adjustment portion which includes a contact portion that comes into contact with a bottom surface of the plate-like member, and a movable portion that is provided to be movable along a vertical direction below a position on the bottom surface, that is different from a contact position at which the contact portion comes into contact with the bottom surface, the attitude adjustment portion being used for adjusting an attitude of the plate-like member; and an attitude fixing portion which includes an opposing portion that opposes a surface of the plate-like member, and an adhesive that causes the surface and the opposing portion to adhere onto each other, and fixes the attitude of the plate-like member after the adjustment by the attitude adjustment portion, in which an energizing path provided from the plate-like member to a frame ground of the image reading device via the movable portion is shut off.

### Note 2

The image reading device according to note 1, in which the contact portion has conductivity and is electrically connected to the frame ground.

### Note 3

The image reading device according to note 1 or 2, in which the movable portion is formed of a material having an insulating property.

### Note 4

The image reading device according to note 1 or 2, in which the movable portion is arranged at a position apart from the bottom surface after the fixing of the attitude of the plate-like member by the attitude fixing portion.

### Note 5

The image reading device according to note 1 or 2, including: an insulating member interposed between the movable portion and the bottom surface.

### Note 6

An image forming apparatus, including: the image reading device according to any one of claims 1 to 5; and an image forming portion which forms an image read by the image reading device from the document sheet on a sheet.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image reading device, comprising:
a light-emitting portion which emits light toward a document sheet;
a lens which collects the light that has been emitted by the light-emitting portion and reflected by the document sheet;
a substrate on which a photoelectric conversion element is mounted, the photoelectric conversion element outputting, in accordance with entering of the light that has passed through the lens, an electric signal corresponding to the light;
a plate-like member which has conductivity, is arranged in an attitude along a horizontal plane, has the substrate fixed to an upper surface thereof, and is electrically connected to a ground of the substrate;
an attitude adjustment portion which includes a contact portion that comes into contact with a bottom surface of the plate-like member, and a movable portion that is provided to be movable along a vertical direction below a position on the bottom surface, that is different from a contact position at which the contact portion comes into contact with the bottom surface, the attitude adjustment portion being used for adjusting an attitude of the plate-like member; and
an attitude fixing portion which includes an opposing portion that opposes a surface of the plate-like member, and an adhesive that causes the surface and the opposing portion to adhere onto each other, and fixes the attitude of the plate-like member after the adjustment by the attitude adjustment portion, wherein
an energizing path provided from the plate-like member to a frame ground of the image reading device via the movable portion is shut off.

2. The image reading device according to claim 1, wherein
the contact portion has conductivity and is electrically connected to the frame ground.

3. The image reading device according to claim 1, wherein
the movable portion is formed of a material having an insulating property.

4. The image reading device according to claim 1, wherein
the movable portion is arranged at a position apart from the bottom surface after the fixing of the attitude of the plate-like member by the attitude fixing portion.

5. The image reading device according to claim 1, comprising:
an insulating member interposed between the movable portion and the bottom surface.

6. An image forming apparatus, comprising:
the image reading device according to claim 1; and
an image forming portion which forms an image read by the image reading device from the document sheet on a sheet.
